(19) United States
(12) Patent Application Publication
(10) Pub. No.: US 2006/0162509 A1
(43) Pub. Date: Jul. 27, 2006

(54) Pipe wrench assembly

(76) Inventor: Ching-Shu Wang, Ta-Li City (TW)

Correspondence Address: CHARLES E. BAXLEY, ESQ., 90 JOHN STREET, THIRD FLOOR, NEW YORK, NY, 10038, US

(21) Appl. No.: 11/042,725

(22) Filed: Jan. 24, 2005

(51) Int. Cl. B25B 7/12

(52) U.S. Cl. 81/355; 81/352

(57) ABSTRACT

An improved pipe wrench assembly includes a first and a second arms, a first and a second movable wrench members disposed on the front ends of the first and second arms respectively, a guide plate separately extended from the rear ends of the first and second movable wrench members, a sliding groove disposed on the guide plate, and an insert pin pivotally coupled in the sliding groove; wherein another end of the insert pin of the first movable wrench member is fixed to a second handle and another end of the insert pin of the second movable wrench member is fixed to a first handle. With the insert pin and the sliding groove, the first and second movable wrench members can produce a parallel clamping movement when the pipe wrench is clamped and released.

### BACKGROUND OF THE INVENTION

1. Field of the Invention

The present invention relates to a pipe wrench assembly, and more specifically to a pipe wrench having a pair of movable wrench members and a guide plate disposed at a rear end of the movable wrench member, such that the movable wrench members can produce a parallel clamping movement.

2. Description of the Related Art

In general, conventional wrenches such as vises or micro pliers usually come with a pair of clamping wrench members disposed at the front end of the wrench in a cross aslant fashion. If a user exerts a force on the wrench to clamp a tubular or cylindrical work piece, then the work piece may slip out of the wrench easily, and the tubular or cylindrical work piece cannot be clamped or fixed by such wrench.

In view of the foregoing shortcomings, manufacturers design a pipe wrench assembly to fix a tubular or cylindrical work piece such as a water pipe. Referring to FIG. 1, the pipe wrench includes a wrench head section 2 disposed at the front ends of two handle sections 1 separately, and each wrench head section 2 has an arm 3 extended there from, and a front end of the arm 3 is pivotally coupled to the movable wrench member 4, wherein the wrench head sections 2 of the two handle sections 1 are stacked with each other and pivotally coupled by an axle 5. Therefore, a user can adjust the angle of the movable wrench member 4 to drive the two wrench members 4 to clamp a work piece by a parallel clamping and prevent the work piece from falling off.

However, the angle included between the movable wrench members 4 has to be adjusted by users manually, and the center of the axle 5 has to be linearly aligned with the center of the work piece, or else the work piece will be situated at a deviated position (as shown in the position of the dotted line), and the reaction of clamping the work piece will change the angle between the two movable wrench members 4, which will cause the work piece to fall off.

### SUMMARY OF THE INVENTION

Therefore, it is a primary objective of the present invention to provide an improved pipe wrench assembly. With an insert pin and a guide plate together, the first and second movable wrench members can automatically produce a horizontal clamping movement when the pipe wrench is clamped and released, and thus a user needs not to adjust the angle between the first and second movable wrench members. The present invention provides an easy and convenient way for users to use a pipe wrench and assures the clamping effect.

Further, the guide plate of the first and second movable wrench members can be situated on the opposite sides of the pipe wrench, such that the first and second wrench handles, the first and second wrench heads, and the first and second movable wrench members respectively have identical structures and are symmetrical sideway. Therefore, the invention can reduce the manufacturing time for making the mold and eliminate other manufacturing processes, and definitely can lower the manufacturing cost.

The technical measure taken by the present invention to overcome the foregoing shortcomings of the prior art is described below.

An improved pipe wrench assembly comprises: a first and a second wrench handles, both being hollow inside and substantially open on the corresponding sides; a first and second wrench heads, for fixing the front ends of the first and second wrench handles onto the rear ends of the first and second wrench heads respectively, and the head sections of the first and second wrench heads being stacked with each other and pivotally coupled by an axle, and a first and a second arms being disposed at the front ends of the head sections of the first and second wrench heads respectively; wherein the first and second wrench handles install a clamping control set therein for controlling an angle between the first and second wrench handles; wherein the front ends of the first and second arms are pivotally coupled with a first and a second movable wrench members, and a guide plate is extended separately from the rear ends of the first and second movable wrench members, and a sliding groove is disposed on the guide plate, and an insert pin is pivotally coupled into the sliding groove; wherein another end of the insert pin of the movable wrench member is fixed to the second handle and another end of the insert pin of the second movable wrench members is fixed to the first wrench handle.

### BRIEF DESCRIPTION OF THE DRAWINGS

To make it easier for our examiner to understand the objective of the invention, its structure, innovative features, and performance, we use a preferred embodiment together with the attached drawings for the detailed description of the invention.

FIG. 1 is a schematic plane view of a conventional prior pipe wrench;

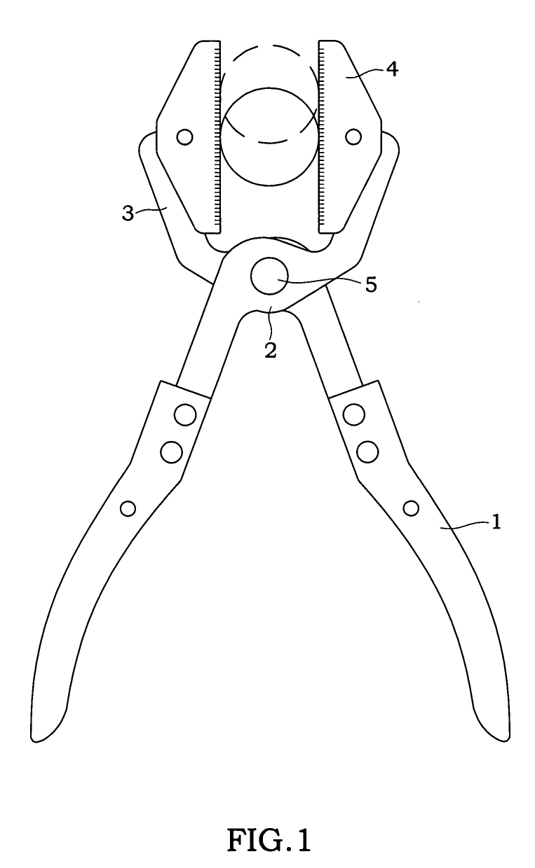

FIG. 2 is an exploded view of a pipe wrench of the present invention;

FIG. 3 is a perspective view of a pipe wrench according to a first preferred embodiment of the present invention;

FIG. 4 is a schematic plane view illustrating the movements of a pipe wrench of the present invention;

FIG. 5 is another schematic plane view illustrating the movements of a pipe wrench of the present invention;

FIG. 6 is a schematic plane view of a pipe wrench according to a second preferred embodiment of the present invention; and

FIG. 7 is a schematic plane view of a pipe wrench according to a third preferred embodiment of the present invention

### DETAILED DESCRIPTION OF THE PREFERRED EMBODIMENTS

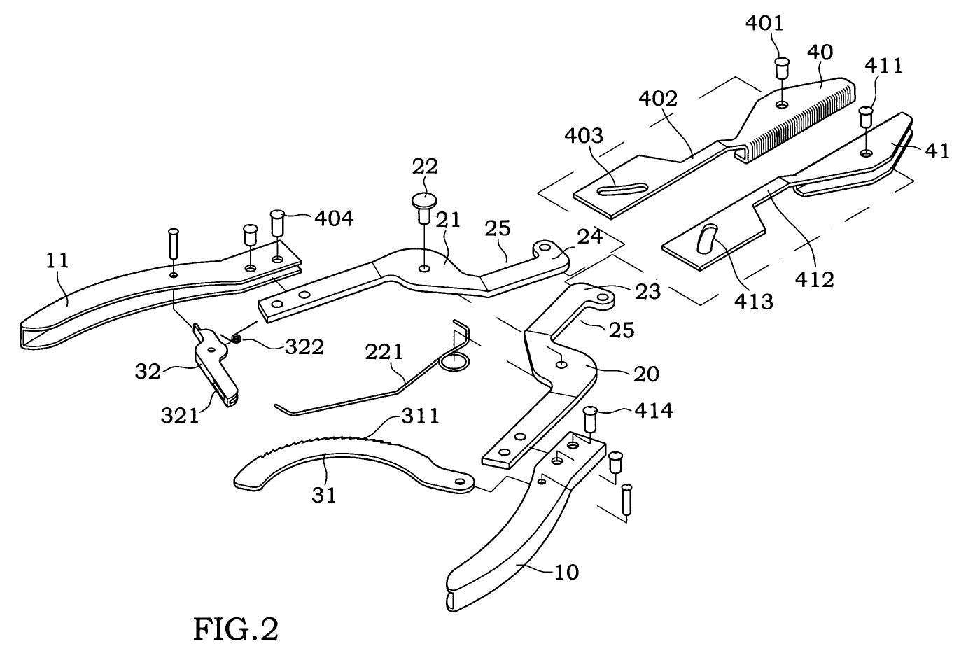

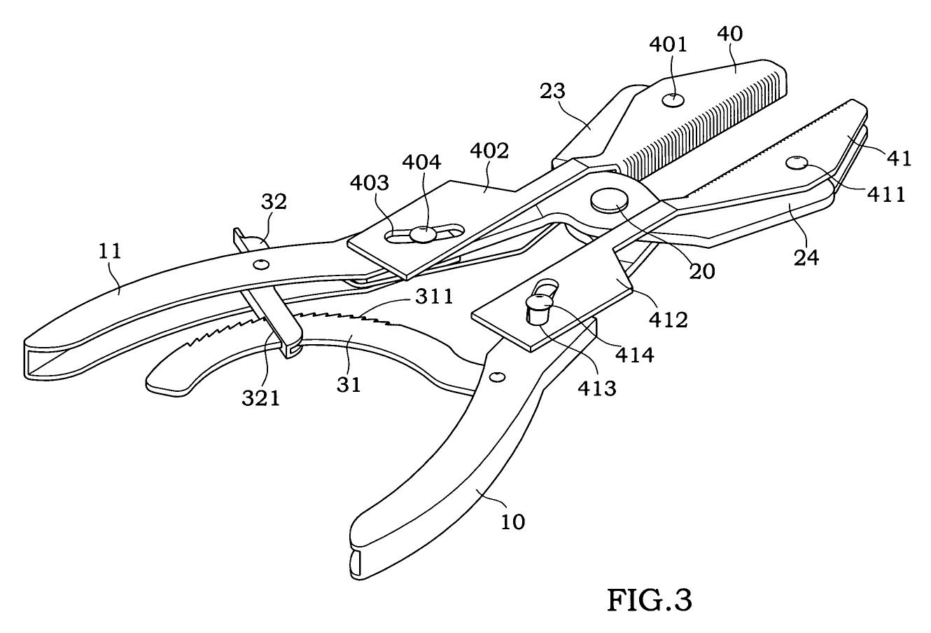

Referring to FIGS. 2 and 3, an improved pipe wrench assembly is illustrated. The improved pipe wrench assembly comprises:

a first and a second wrench handles 10, 11, and the first and second wrenches 10, 11 is hollow inside and in an open form on the lateral sides with respect to each other;

a first and a second wrench heads 20, 21, and their rear sections are of a long plate structure and fixed by a plurality of fixtures onto the front ends of the first and second wrench handles 10, 11, and the head sections of the first and second wrench heads 20, 21 are of a circular plate structure, and the two head sections are stacked with each other and an axle 22 passes through the center of the head sections, and the first wrench head 20 has a resilient member 221, and the rear end of the resilient member 221 is hooked into the second wrench handle 11, such that a user's hand can hold the first and second handles 10, 11 to drive the axle 22 to pivotally rotate about the center of the axle 22; wherein a first and a second arms 23, 24 are disposed at the front ends of the head sections of the first and second wrench heads 20, 21, and the first and second arms 23, 24 are bent outward to define an accommodating space 25 at the inner side of the first and second arms 23, 24;

a clamping control set 30, and the clamping control set 30 has a one-way ratcheted plate 31 pivotally coupled into the first wrench handle 10, and the one-way ratcheted plate 31 is of an arc plate structure having a plurality of one-way ratchets outside, and a positioning plate 32 is pivotally coupled into the second wrench handle 20 and corresponsive to the one-way ratcheted plate 31, and a positioning hole 321 passes through the positioning plate 32, such that the one-way ratcheted plate 31 can install a device, and the positioning plate 32 has a positioning spring 322 disposed thereon for providing a resilience force to return the positioning plate 32 to its original position, and the angle between the first and second wrench handles can be controlled by the one-way latch of the positioning hole 321 and the one-way ratchet 311;

a first and a second movable wrench members 40, 41, and the front ends of the first and second movable wrench members are hollow and a pivotal axle 401, 411 passes through and wraps the front ends of the first and second arms 23, 24, and the first and second movable wrench members 40, 41 are in a closed form with respect to each other, such that the first and second wrench members 40, 41 can be pivotally rotated in the accommodating space 25 for clamping the work piece; and the second and second wrench members 40, 41 at their rear ends have a guide plate 402, 412 each, and the guide plate 402, 412 has a sliding groove 403, 413, and the sliding groove 403, 413 is an arc penetrating structure having an insert pin 404, 414 pivotally coupled in the sliding groove 403, 413; wherein another end of the insert pin 404 of the first movable wrench member 40 is coupled to the second wrench handle 11, and another end of the insert pin 414 of the second movable wrench member 41 is coupled to the first wrench handle 10; wherein the guide plates 402, 412 of the first and second movable wrench members 40, 41 are situated on the same side of the pipe wrench.

With the understanding of the foregoing structure, the principle of the movement according to the present invention will be described in details as follows:

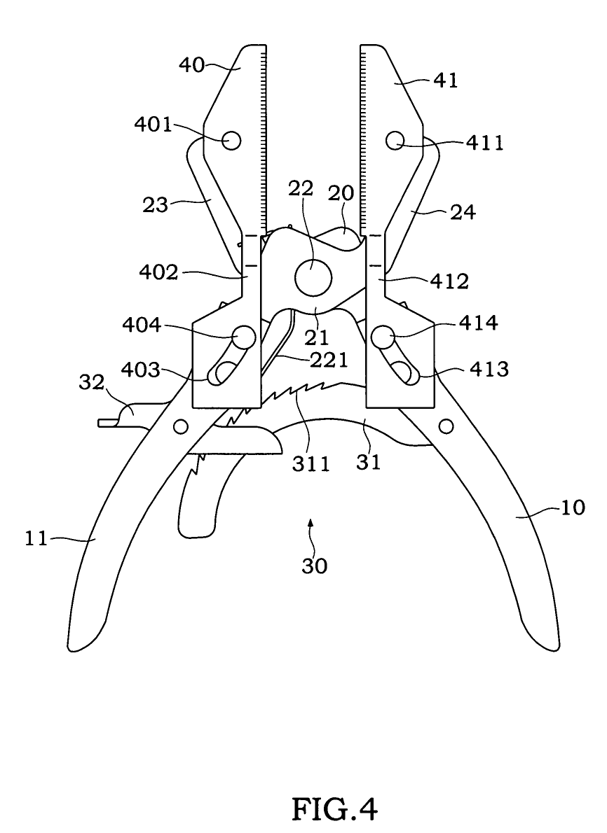

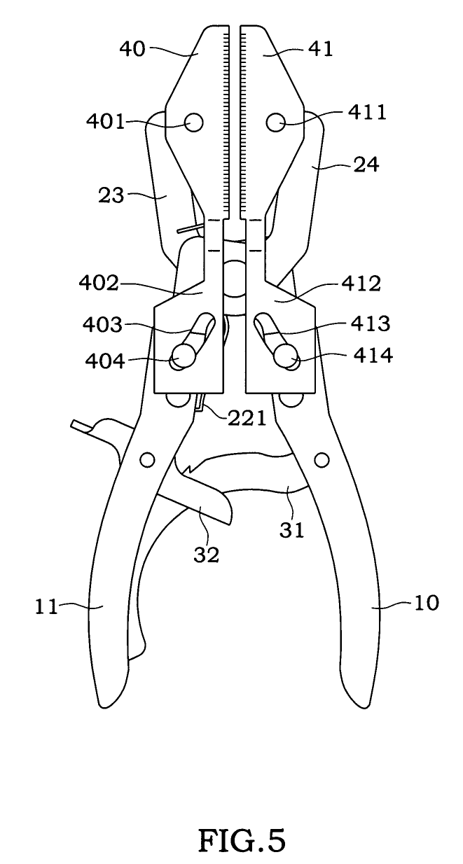

Referring to FIG. 4, the one-way ratchet 311 of the one-way ratcheted plate 31 passes through the positioning hole 321 in the direction of the ratchets when a user exerts a force onto the first and second wrench handles 10, 11, and the positioning plate 32 is latched at the rear of the one-way ratchet 311 by the resilient reaction of the positioning spring 322, such that the pipe wrench can maintain the force for continuously clamping the work piece, and the insert pins 404, 414 in the sliding grooves 403, 413 can slide as the first and second wrench handle 10, 11 is clamped and released, and a predetermined shape of the sliding groove 403, 413 can be controlled synchronously and the angle between the first and second movable wrench members 40, 41 can be adjusted, so that a horizontal clamping movement (as shown in FIG. 5) can be maintained during the clamping process. After a user finishes with the work, the user just needs to poke the positioning plate 32 to drive the positioning plate 32 to be separated from the one-way ratchet 311, and the resilient member 221 can automatically spread the pipe wrench open.

With the insert pin 404, 414 and the sliding groove 403, 413, the insert pin 404, 414 can slide with a predetermined shape of the sliding groove 403, 413 when the pipe wrench is clamped and released, so that the first and second movable wrench members 40, 41 can automatically adjust the clamping angle and produce a parallel clamping movement.

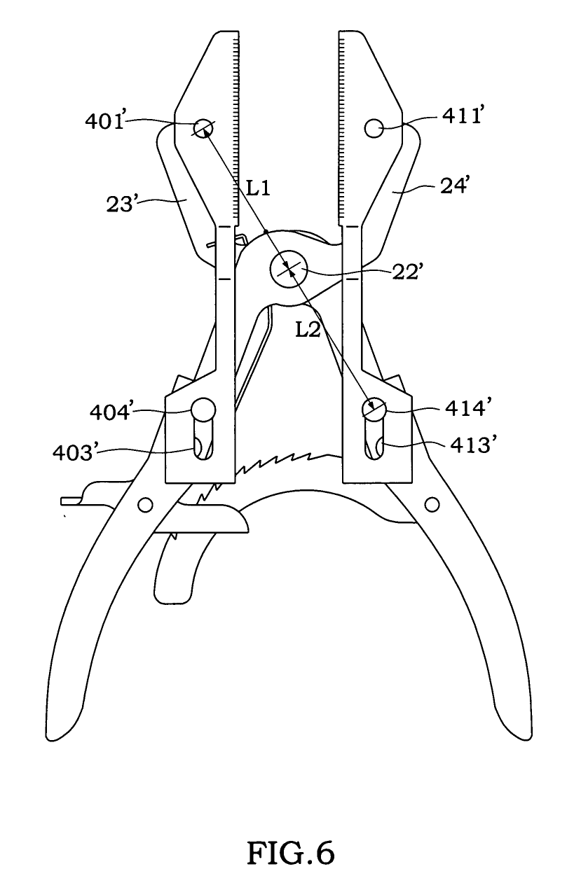

Referring to FIG. 6, a second preferred embodiment of the present invention is illustrated; wherein the linear distance (as indicated by L1 in FIG. 6) between the pivotal axle 401′, 411′ of the first and second arms 23′, 24′ to the axle 22′ is equal to the linear distance (as indicated by L2 in FIG. 6) between the axle 22′ and the insert pin 404′, 414′. The axle 404′, 414′ are situated precisely at the center, such that the center of the axle 22′ and the insert pins 404′, 414′ form a rectangular corresponding shape, and the axle 22′ is situated precisely at the center of the axle 22′, such that when the first and second wrench handles 10′, 11′ are clamped with the axle 22′ at the center, the insert pins 404′, 414′ also move linearly with respect to the axle 401′, 411′ accordingly. In other words, the insert pins 404′, 414′ move in a direction parallel to the sliding grooves 403′, 413′ to reduce the friction between the insert pin 404′, 414′ and the sliding grooves 403′, 413′ and make the clamping movement of the pipe wrench smoother.

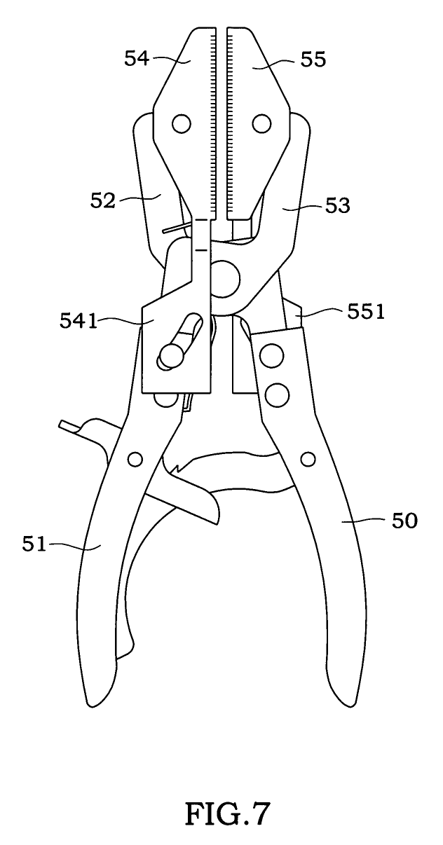

Referring to FIG. 7, a third preferred embodiment of the present invention is illustrated. The guide plate 541, 551 of the first and second movable wrench members 54, 55 are situated on the opposite sides of the pipe wrench, such that the first and second wrench handles 50, 51, the first and second wrench heads 52, 53 and the first and second movable wrench members 54, 55 have identical structures and is symmetrical sideway, and thus these components can share the same mold and related component modules for the manufacture so as to lower the manufacturing time required for making the mold and eliminate additional manufacturing processes, and the present invention can definitely lower the manufacturing cost.

In summation of the above description, the present invention herein enhances the performance over the conventional structure and further complies with the patent application requirements and is submitted to the Patent and Trademark Office for review and granting of the commensurate patent rights.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved pipe wrench assembly, comprising:
a first and a second wrench handles, both being hollow inside and substantially open on corresponding sides;
a first and second wrench heads, for fixing the front ends of said first and second wrench handles onto the rear ends of said first and second wrench heads respectively, and the head sections of said first and second wrench heads being stacked one on top of the other and pivotally coupled by an axle, and a first and a second arms being disposed at the front ends of said head sections of said first and second wrench heads respectively; wherein said first and second wrench handles installs a clamping control set therein for controlling an included angle between said first and second wrench handles;
wherein the front ends of said first and second arms are pivotally coupled with a first and a second movable wrench members, and a guide plate is extended separately from the rear ends of said first and second movable wrench members, and a sliding groove is disposed on said guide plate, and an insert pin is pivotally coupled into said sliding groove; wherein another end of said insert pin of said movable wrench member is fixed to said second handle and another end of said insert pin of said second movable wrench members is fixed to said first wrench handle;
with said insert pin and said sliding groove, said first and second movable wrench members can produce a parallel clamping movement when said pipe wrench is clamped and released.

2. The improved pipe wrench assembly of claim 1, wherein said clamping control set comprises a one-way ratcheted plate pivotally coupled in said first wrench handle and a positioning plate pivotally and correspondingly coupled in said second wrench handle, and said positioning plate includes a positioning hole for installing said one-way ratcheted plate.

3. The improved pipe wrench assembly of claim 2, wherein said positioning plate comprises a positioning spring for providing a resilience force to resume said positioning plate to its original position.

4. The improved pipe wrench assembly of claim 1, wherein said first and second arms are extended and turned outward to define an accommodating space.

5. The improved pipe wrench assembly of claim 4, wherein said first and second movable wrench members have a hollow front end each, and a pivotal axle passes through and wraps the front ends of said first and second arms.

6. The improved pipe wrench assembly of claim 5, wherein said first and second movable wrench members are in a closed form with respect to each other.

7. The improved pipe wrench assembly of claim 1, wherein said sliding groove is an arc penetrating groove.

8. The improved pipe wrench assembly of claim 1, wherein the linear distance between said axle of said first and second arms is equal to the linear distance between said axle to said insert pin.

9. The improved pipe wrench assembly of claim 8, wherein said sliding groove is a parallel penetrating groove.

10. The improved pipe wrench assembly of claim 1, wherein said guide plates of said first and second movable wrench members are situated on the same side of said pipe wrench.

11. The improved pipe wrench assembly of claim 1, wherein said guide plates of said first and second movable wrench member are situated on the opposite sides of said pipe wrench.
